(19) United States
(12) Patent Application Publication
(10) Pub. No.: US 2015/0086886 A1
(43) Pub. Date: Mar. 26, 2015

(54) Fuel Cell Stack Arrangement with at least one Multi-Functional End Plate

(71) Applicant: Daimler AG, Stuttgart (DE)

(72) Inventors: Felix Blank, Konstanz (DE); Simon Hollnaicher, Albershausen (DE); Martin Keuerleber, Stuttgart (DE); Jan Martinec, Prag (CZ); Cosimo Mazzotta, Ulm (DE); Uwe Pfister, Winnenden (DE); Michael Procter, North Vancouver (CA); Pavel Sarkady, Prag (CZ); Wolfgang Schmid, Illerkirchberg (DE); Holger Stark, Allmersbach im Tal (DE)

(21) Appl. No.: 14/390,639

(22) PCT Filed: Mar. 27, 2013
(86) PCT No.: PCT/EP2013/000925

§ 371 Date: Oct. 3, 2014

(30) Foreign Application Priority Data
Apr. 5, 2012 (DE) 10 2012 006 948.0

(51) Int. Cl. H01M 8/24; H01M 8/04

(52) U.S. Cl. CPC H01M 8/2485; H01M 8/04104; H01M 8/04067; H01M 8/04126
USPC 429/413; 429/458; 429/434; 429/460

(57) ABSTRACT

A fuel cell stack arrangement includes a fuel cells arranged between a first and a second end plate. At least one of the end plates is designed as a channel end plate with at least one channel. The channel has a stack opening, which is opened in the direction of the stack, and a second opening. The stack opening and the second opening are connected to each other via a channel section and are arranged at a distance to each other in a top view looking down on the channel end plate.

### BACKGROUND AND SUMMARY OF THE INVENTION

Exemplary embodiments of the invention relate to a fuel cell stack arrangement with a plurality of fuel cells, having a first and a second end plate, wherein the fuel cells are arranged in the form of a stack between the end plates, wherein at least one of the end plates is designed as a channel end plate with at least one channel, wherein the channel has a stack opening that is opened in the direction of the stack and a second opening, and wherein the stack opening and the second opening are connected to each other via a channel section.

Fuel cell systems are known in mobile and stationary applications and serve to convert chemical energy into electrical energy via an electrochemical procedure. In typical construction methods, the fuel cell systems comprise a plurality of fuel cells, which have a flat, rectangular shape and are arranged in stacks to achieve a required level of operating voltage of the fuel cell system. Each fuel cell comprises a cathode and anode region, which are separated from each other by a proton-conducting membrane. The fuel cell stack typically has locking plates added to the end of it.

For example, German patent document DE 10 2004 047 944 A1, discloses a fuel cell system with a first and a second fuel cell stack that are arranged alongside each other. The fuel cell stacks are each placed in a housing, which are each locked by a plate on their front ends. The plates have apertures for the various fluids for supplying the fuel cell stack. A pipework for conducting the fluids is arranged on the plates. A connecting block which, on the one hand, connects the housings of the second fuel cell stack and, on the other hand, separates the fluids, is positioned between the housings of the fuel cell stack.

Exemplary embodiments of the invention are directed to a compact and robust fuel cell arrangement.

The invention thus relates to a fuel cell stack arrangement, which is suited and/or designed particularly preferably for a mobile application, in particular a vehicle. It is particularly preferable for the fuel cell stack arrangement to provide the drive energy for the vehicle.

The fuel cell stack arrangement comprises a plurality of fuel cells, which are preferably designed in plate form and each have a cathode and anode region, which are separated from each other by a membrane, in particular a proton-conducting membrane.

The fuel cell stack arrangement comprises a first and a second end plate, wherein the end plates can preferably be designed as separate components, or alternatively as subdomain, e.g. a housing. The fuel cells are arranged in the form of a stack between the end plates. In particular, the fuel cells between the end plates are pre-charged and indeed in such a way that a power flow runs from the first end plate to the second end plate. Alternatively to this, the end plate(s) only form(s) mechanical coverings of the stack. The first and/or second end plates can be designed as one part or as several parts.

At least one of the end plates, preferably both end plates, are designed as a channel end plate that has at least one channel. In particular, the channel end plate is designed as a separate component. It is preferable for the channel end plate in the top view to be designed rectangularly or roughly rectangularly and/or roughly prismatically.

The channel comprises a stack opening, which is opened in the direction of the stack, and a second opening, wherein the stack opening and the second opening are fluidically connected to each other via a channel section, such that a fluid from the stack opening can flow via the channel section to the second opening, or in the opposite direction. The channel can be designed as round or rectangular, in a cross-section perpendicular to its direction of extension. In particular, the channel is designed as being sectionally closed in the rotational direction around its direction of extension.

Within the scope of the invention, it is proposed that the stack opening and the second opening are to be arranged, in the top view looking down on the channel end plate, at a distance to each other. The direction of the top view corresponds in particular to the stack direction of the stack.

Due to this constructive embodiment, it is achieved that the channel comprises a channel section, which runs at right angles to the stack direction and is integrated into the channel end plate. As well as a purely implementational function of the channel, the channel end plate thus implements a separator function or guiding function, wherein, through the channel, an inflow point and an outflow point of the channel can be selected at any point on the channel end plate.

This constructive improvement is advantageous in that pipe or line sections, which otherwise have to be fitted onto the end plate, can be integrated into the end plate. This leads to, on the one hand, construction space being saved, such that the fuel cell stack arrangement can be embodied in more compact form. On the other hand, this improvement increases the robustness of the fuel cell stack arrangement, since, for example, inadvertent catching, as can happen during external guiding as an interference contour, is excluded by the integrated channel.

It is particularly preferable for the channel section, in the top view, to have a minimum gap between the stack opening and the second opening of 5 cm, preferably 15 cm and in particular 20 cm.

In a preferred constructive embodiment of the invention, the channel is designed to conduct a fluid, in particular a fuel, an oxidant or a coolant. The fuel is hydrogen (H₂), with the oxidant being atmospheric air or oxygen (O₂) and with the coolant being de-ionised water. Thus, the channel end plate becomes a part of the fluid conduction in the fuel cell stack arrangement. By integrating the channel into the channel end plate, external sealings can be reduced in this or even in the other embodiments, such that the susceptibility to defects of the fuel cell arrangement is reduced.

In a potential constructive embodiment of the invention, the second opening is designed as a second stack opening, such that the channel forms a deviation in the fuel cell stack arrangement. A deviation integrated into the channel end plate in such a way is particularly space-saving; sealing points are additionally saved, since only sealings between the stack opening of the channel end plates and the stack must be present, while sealings between the end plate and an external conduit can be saved, however. If further openings in the direction of the stack are still provided, the channel can also form a collection structure or a separation structure.

In a preferred embodiment of the invention, the second opening is designed as an external opening, which is opened out into an environment of the fuel cell stack. If the channel end plate forms a part of a housing of the fuel cell arrangement, which encloses the fuel cell stack, then the channel in the channel end plate is conducted outwardly, such that the fluids can be conducted to or discharged from the stack.

In a potential constructive embodiment of the invention, the channel is designed to conduct the coolant and is insulated electrically from the environment, such that the channel implements an insulating section for the coolant. During operation, due to the series connection of the fuel cells, there is a very high operating voltage in the stack, wherein the coolant also comes into contact with live regions of the stack. In order to avoid short-circuiting between the stack and the environment by the coolant as a short-circuit line, the coolant is guided via an insulating section to skilfully lengthen the distance covered by the potential short-circuit line and, in this way, increase the ohmic resistance of the short-circuit line. It is preferable for the channel to have, as an insulating section, a minimum length of 20 cm and preferably a minimum of 30 cm.

In another embodiment or in a development of the invention, the channel is designed as part of an oxidant supply, wherein the length of the channel with the end plate implements a swirl region for the oxidant. In this swirl region, the flow of oxidants can be influenced in a targeted manner. It is thus possible, for example, to introduce, for example, supports or other disruption agents into the channel, in order to alter the style of flow of the oxidants.

In a possible development of the invention, the channel comprises two external openings and a stack opening, wherein the first external opening is and/or can be connected to an oxidant humidifier of the fuel cell stack arrangement and the second external opening is connected to a bypass to the oxidant humidifier. The stack opening is connected to a port of the stack for oxidant supply.

During normal operation of the fuel cell arrangement, it is necessary to supply the oxidant with a sufficient amount of humidity (water), in order to prevent the proton-conducting membrane from drying out. This is implemented by having the oxidant flow through the oxidant humidifier. During a starting operation, in particular during a cold-start, of the fuel cell arrangement, it is, however, advantageous to circumvent the oxidant humidifier via the bypass so as not to introduce too much humidity into the fuel cell stack arrangement.

The T-structure or collection structure required for this is integrated into the channel end plate. In particular, the first and second external openings are fluidically connected to each other in a mixing region in the channel end plate, such that it is also possible for a part of the oxidant to be guided through the oxidant humidifier and for a part of the oxidant to be guided through the bypass, wherein the humidified and non-humidified oxidant are mixed together in the mixing region.

In a further embodiment of the invention, the channel can be designed as a cascade or as a water separator. For this, the end plate has an outlet opening, via which trapped water can be discharged.

In a possible constructive embodiment of the invention, the fuel cell stack arrangement comprises a housing, in which the stack is arranged, and which is locked and sealed by the channel end plate at its end. In particular, the housing is tight around the stack in the rotational direction and is sealed at its end or front face by the first and second end plate.

In order to be able to implement the various functions, it is preferable for the channel end plate to be designed as a material hybrid, wherein a carrier structure from a first material and a functional support onto the carrier structure from a second material are designed. For example, the first material is designed as a fiber composite or as a metallic material in order to achieve a sufficient level of mechanical rigidity. The second material is preferably designed as a synthetic material, such that this, according to application, can form a sealing from the housing, insulation from the coolant, a chemically neutral environment for the oxidant or fuel or electrical insulation for the stack. It is particularly preferred for the end plate to be designed in such a way that the functional support forms a sealing between the channel end plate and the housing.

In a potential development of the invention, further system components are arranged on the channel end plate and are borne by the channel end plate. Due to the fact that the system components are fitted onto the channel end plate as carriers, the connection between the system components and the stack can be kept very short and, in particular, implemented in a fixed and/or tight manner, such that leakages etc. do not occur. The required pipework between the system components or between the system components and the stack is integrated as the channel or the several channels into the channel end plate(s).

The fuel cell arrangement preferably comprises a mechanical interface for attachment to the vehicle, wherein the mechanical interface is arranged together with the system components on the channel end plate(s). The mechanical interface can consist of several interface sections that are divided into two channel end plates. In particular, one side of the mechanical interface or one of the interface sections is/can be attached to the channel end plate and the other side to the vehicle. The fuel cell arrangement is fixed in the vehicle via the mechanical interface. It is particularly preferred if at least 80%, preferably at least 90% and in particular at least 95% of the weight of the fuel cell arrangement is removed via the mechanical interface.

The advantage of the preferred embodiment is to ensure that the mounting or an exchange of the fuel cell arrangement in the vehicle can be considerably simplified. Since the system components are typically attached to the vehicle independent of the housing, both the system components and the housing with the fuel cell stack must be detached from the vehicle for the demounting of the fuel cell module. This procedure implies that even the delicate connections between the system components and the housing or the fuel cell stack are either to be detached, if first the fuel cell stack is dismantled and then the system components are to be demounted, or at least be loaded, if first the system components are separated from the vehicle and only connected to the housing via the supply line to the fuel cell stack, which is delicate according to the invention.

By contrast, it is proposed that the fuel cell arrangement be embodied as a constructional unit, wherein the system components are attached to the channel end plates and the housing, including the system components, is attached to the vehicle via the mechanical interface. Thus only the mechanical interface must still be detached for the exchange, construction or dismantling of the fuel cell arrangement. Thus the fuel cell arrangement is considerably easier to repair and maintain than in typical constructions.

### BRIEF DESCRIPTION OF THE DRAWING FIGURES

Further features, advantages and effects of the invention arise from the description of preferred exemplary embodiments below, as well as from the appended figures. The following are shown:

FIG. 1 a schematic top view of a fuel cell arrangement having two end plates as an exemplary embodiment of the invention;

FIG. 2 a section through the anode end plate as a channel end plate in FIG. 1;

FIG. 3 a second sectional view perpendicular to the first sectional view of the anode end plate in FIG. 1;

FIG. 4 a schematic, 3-dimensional view of the anode end plate of the preceding figures;

FIG. 5 the cathode end plate in FIG. 1 in the same depiction as the one in FIG. 2 as a channel end plate;

FIG. 6 the cathode end plate in the same depiction as in FIG. 3;

FIG. 7 the cathode end plate in the same depiction as in FIG. 4;

FIG. 8 a schematic top view of a channel end plate with a deviation;

FIG. 9 a schematic top view of a channel end plate with a water separator;

FIG. 10. a potential constructive embodiment of the fuel cell arrangement in FIG. 1.

### DETAILED DESCRIPTION

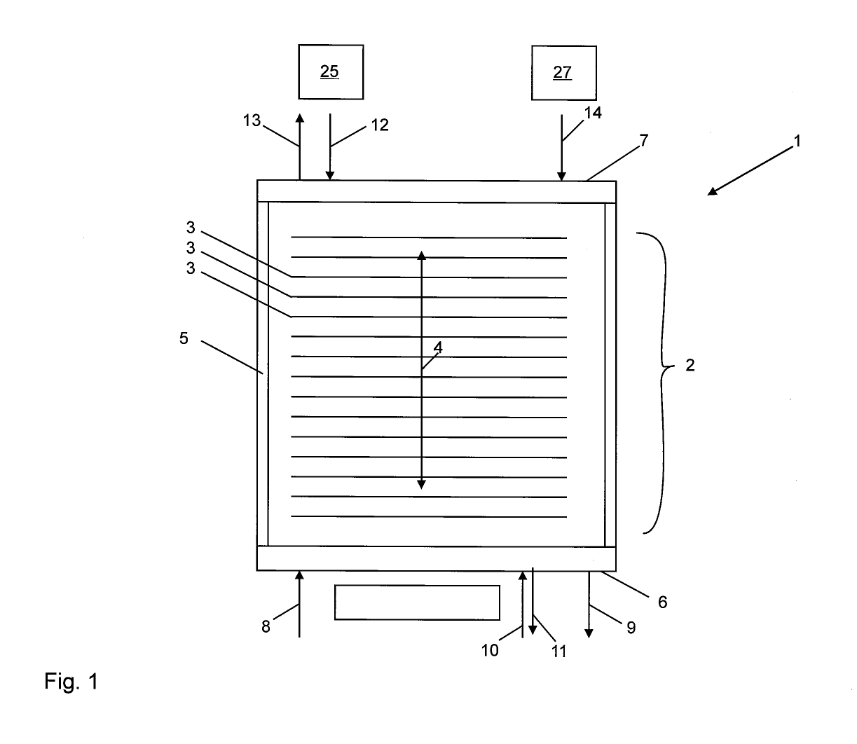

In a schematic top view from above, FIG. 1 shows a fuel cell arrangement 1 as an exemplary embodiment of the invention. The fuel cell arrangement 1 is part of a fuel cell system for the provision of drive energy for a vehicle, e.g. for a personal automobile.

The fuel cell stack arrangement 1 comprises a stack 2 with several fuel cells 3, which are arranged lying on top of one another in a stack direction 4. For example, there are more than 50 or 100 fuel cells 3 in the stack 2. The fuel cells 3 are designed approximately rectangularly in a front top view and each have an anode and cathode region, between which a proton-conducting membrane is arranged. The stack 2 is arranged in a housing 5, which runs continuously around the stack 2, in particular the stack direction 4 and which is locked off at its end by an anode plate 6 and a cathode plate 7 as the end plates. The housing 5 is embodied as a sleeve.

The end plates, i.e., the anode plate 6 and the cathode plate 7, at the same time form the fluidic interface for supplying the fluid required for the operation of the fuel cell stack arrangement 1.

In this way, the anode plate 6 has a hydrogen inlet 8 and a hydrogen outlet 9. In addition, the anode plate 6 has a coolant inlet 10 and a coolant outlet 11.

By contrast, the cathode plate 7 has, as a fluidic interface, an oxidant inlet 12 and an oxidant outlet 13, as well as a bypass inlet 14, via which the oxidant can also be introduced.

The inlet and outlets 8-14 cited have external openings, such that these are fluidically opened to the environment of the fuel cell stack arrangement 1. Within the housing 5, the cited fluids can be conducted into the stack 2, in particular into ports of the stack 2, via stack openings.

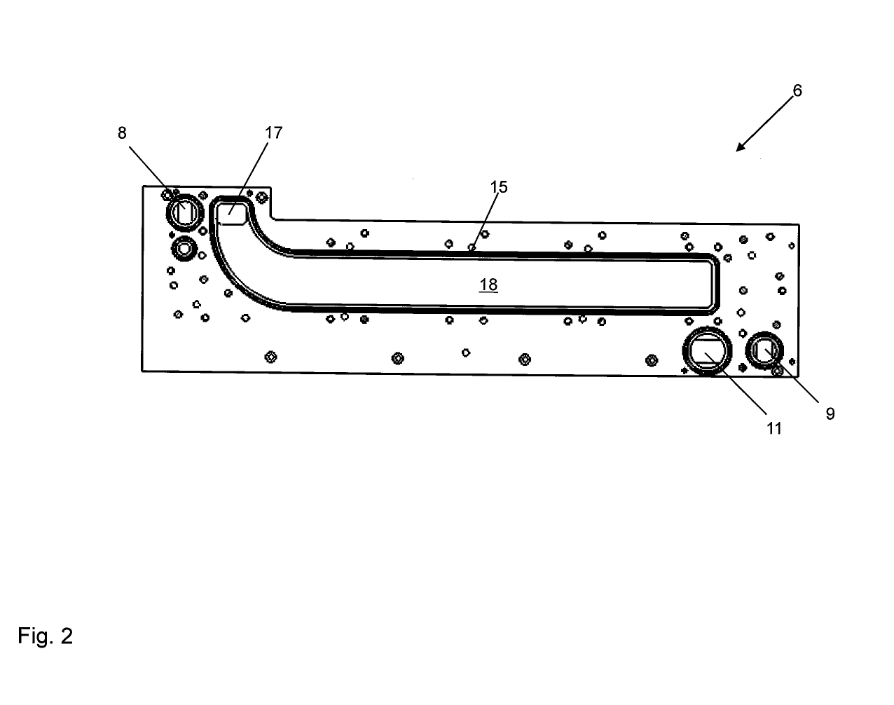

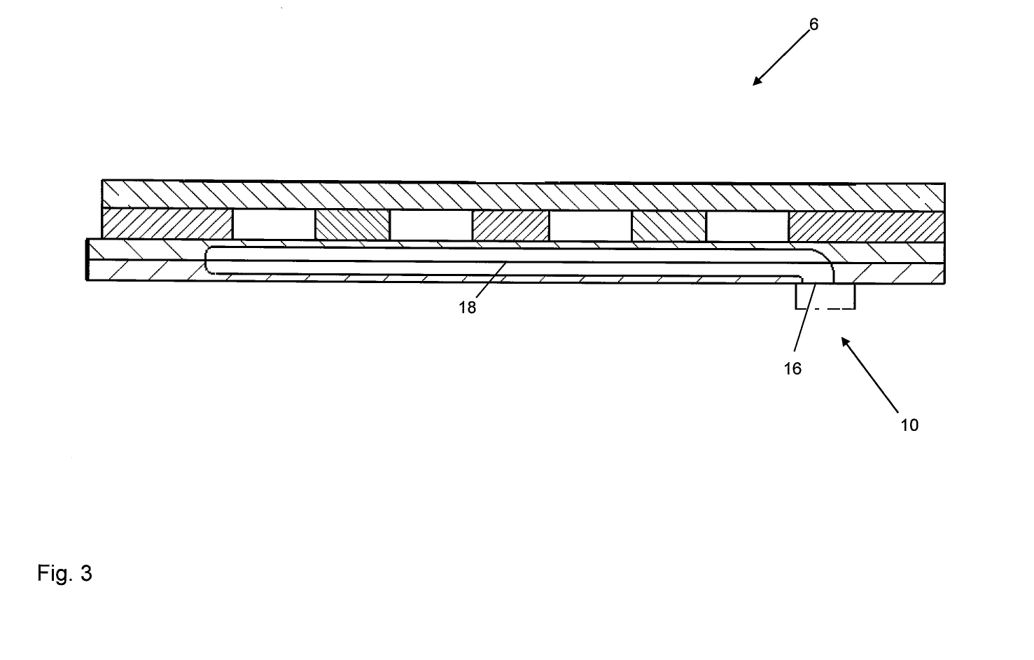

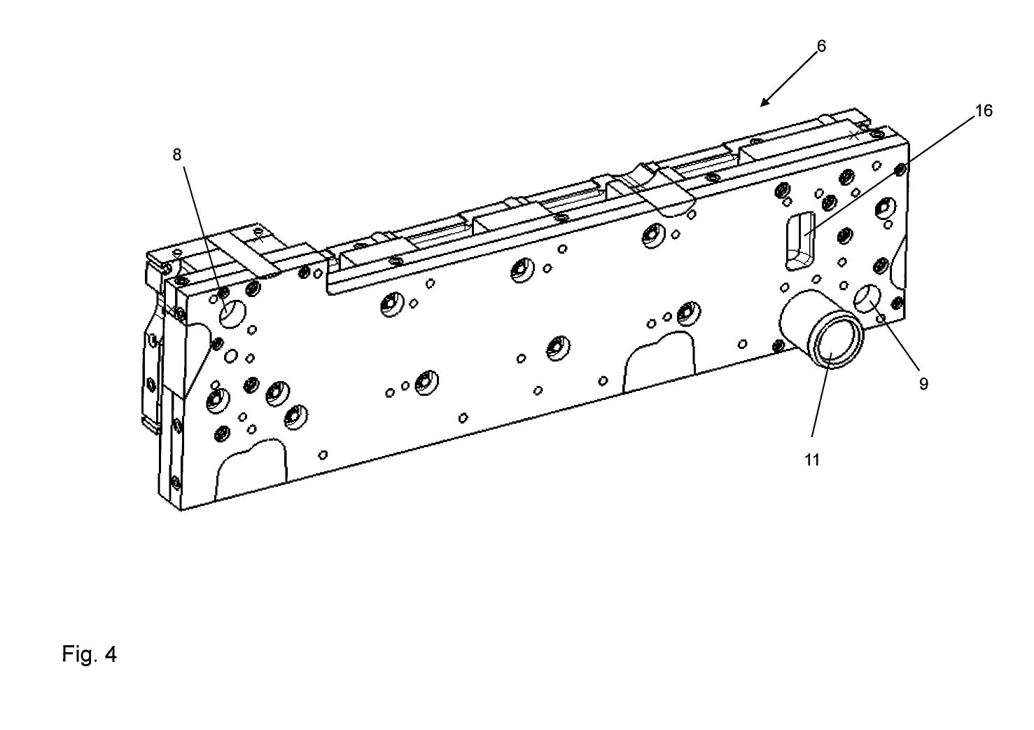

FIG. 2 shows a schematic cross-section perpendicular to the stack direction 4 through the anode plate 6. In the cross-section, in addition to the hydrogen outlet 9, the coolant outlet 11 and the hydrogen inlet 8, a channel 15 is shown, which forms the coolant inlet 10. The anode end plate 6 thus forms a channel end plate. FIGS. 3 and 4 show the anode plate 6 in a cross-section parallel to the stack direction 4 through the channel 15 and in a three-dimensional front top view.

As arises from the synopsis of the drawings, the coolant inlet 10 has a coolant inlet opening 16, which is designed as an external opening. Furthermore, the coolant inlet 10 has a coolant stack opening 17, which is opened into the stack 2. The coolant inlet opening 16 is arranged on the front side and the coolant stack opening 17 is arranged on the rear side of the anode plate 6. A channel section 18 extends between the openings 16 and 17, such that the coolant inlet opening 16, channel section 18 and coolant stack opening 17 form the channel 15. As arises in particular from FIG. 2, the openings 16 and 17 are not arranged superimposably, but rather are positioned as displaced from one another, such that the channel section 18 runs within the anode plate 6. Based on the coolant inlet opening 16, the channel section 18 runs parallel to the surface extension and aligned to the longitudinal extension and perpendicular to the stack direction 4 over at least 50% of the length of the anode plate 6. Then, in the front top view, the channel section 18 diverges upwards and is then fluidically connected to the coolant stack opening 17. In a cross-section perpendicular to the longitudinal extension of the channel section 18, this is designed as a flat, rectangular channel.

One motivation for the skilful extension of the coolant inlet opening 10 through the channel section 18 is that a potential short-circuit line between the fuel cells 3 and other system components is formed by the coolant. As also arises from FIG. 1, a coolant heater 19 can be arranged, for example, directly before the coolant inlet opening 16, which is designed to temper the coolant when the fuel cell stack arrangement 1 is cold-started. If the gap between the coolant stack opening 17 and the heater 19 is selected as being too small, too low an ohmic resistance for the coolant as a conductor is produced, such that there is a risk of short-circuiting. By contrast, due to the skilful extension via the channel section 18, the ohmic resistance is increased to such an extent that such a short-circuit can be prevented.

By integrating the channel section 18 into the anode plate 6, this insulating section can save construction space and be designed free of interference contours. The channel section 18 is designed as a flat channel and runs from a right half (FIG. 2) of the anode plate 6 to a left half.

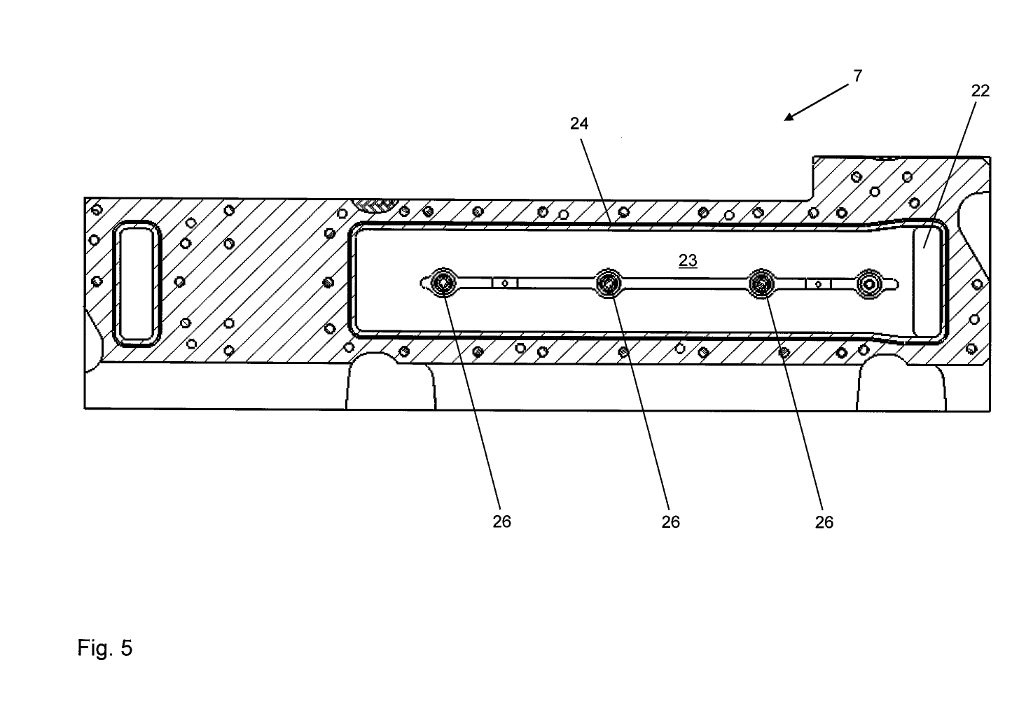

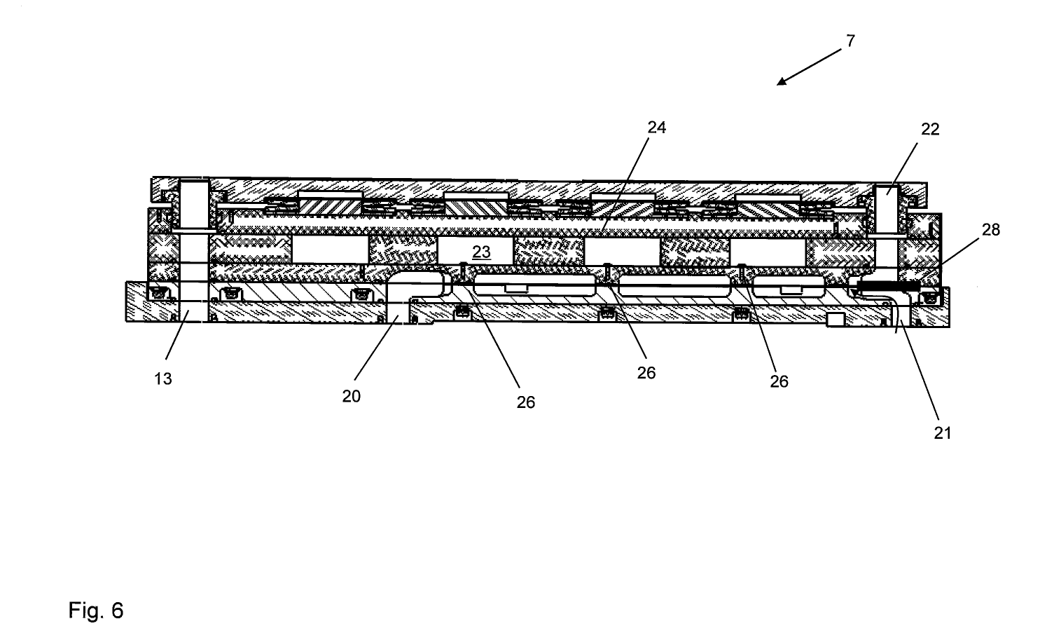

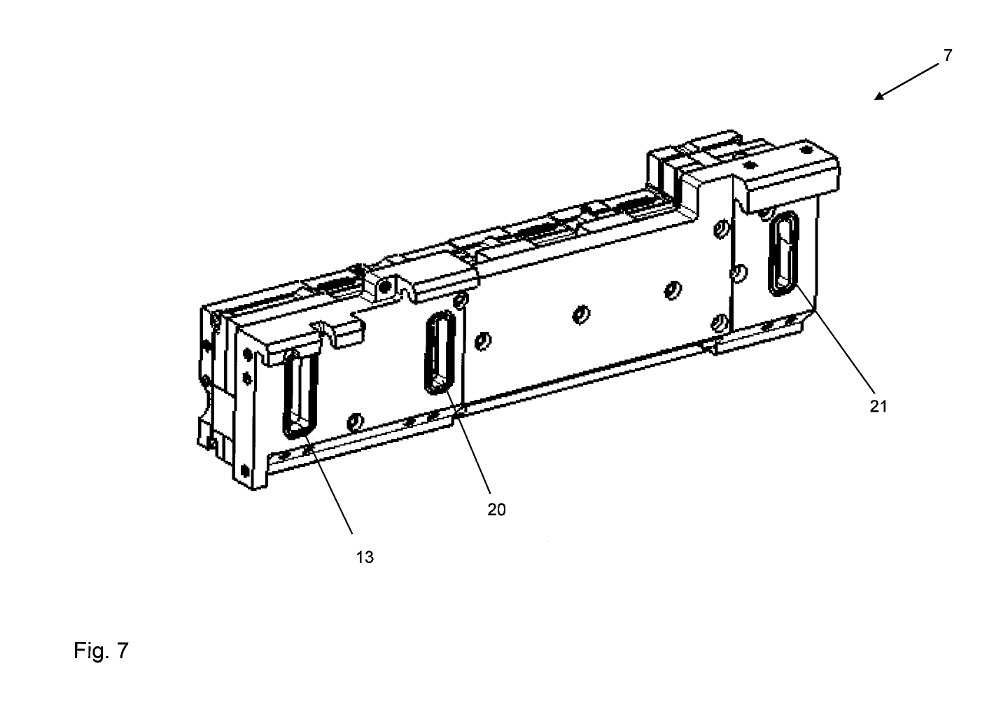

FIGS. 5, 6 and 7, in the same depictions as FIGS. 2, 3 and 4, show the cathode plate 7. An oxidant inlet opening 20 and a bypass inlet opening 21 are arranged on the front side pointing outwards. By contrast, an oxidant stack opening 22, which is fluidically connected to the stack 2, is located on the rear side of the cathode plate 7.

In a similar way to the anode plate, the oxidant inlet opening 20, the oxidant stack opening 22 and a second channel section 23 running therebetween form a second channel 24, wherein the oxidant inlet opening 20 and the oxidant stack opening 22 are arranged displaceably to each other in a front top view and are particularly arranged without overlapping. The channel section 23 also runs parallel to the longitudinal extension of the cathode plate 7 here. The cathode plate 7 is thus also designed as a channel end plate.

A first functionality of the channel section 23 is the swirling of oxidants entering from a humidifier 25 (FIG. 1). In order to reinforce this swirling, interference contours 26 are provided in the form of columnar support regions. As a further expansion, the bypass inlet opening 21 also flows into the channel section 23, such that the channel section 23 can also be used to mix oxidants from the humidifier 25 and from the bypass 27 (FIG. 1) together. For this purpose, a flow deflector 28 can be provided in the inlet region of the bypass inlet 21, which separates the channel section 23 in the end region in such a way that incoming oxidant via the bypass inlet opening 21 must first flow in the direction of the oxidant inlet opening 20 in order to achieve better swirling.

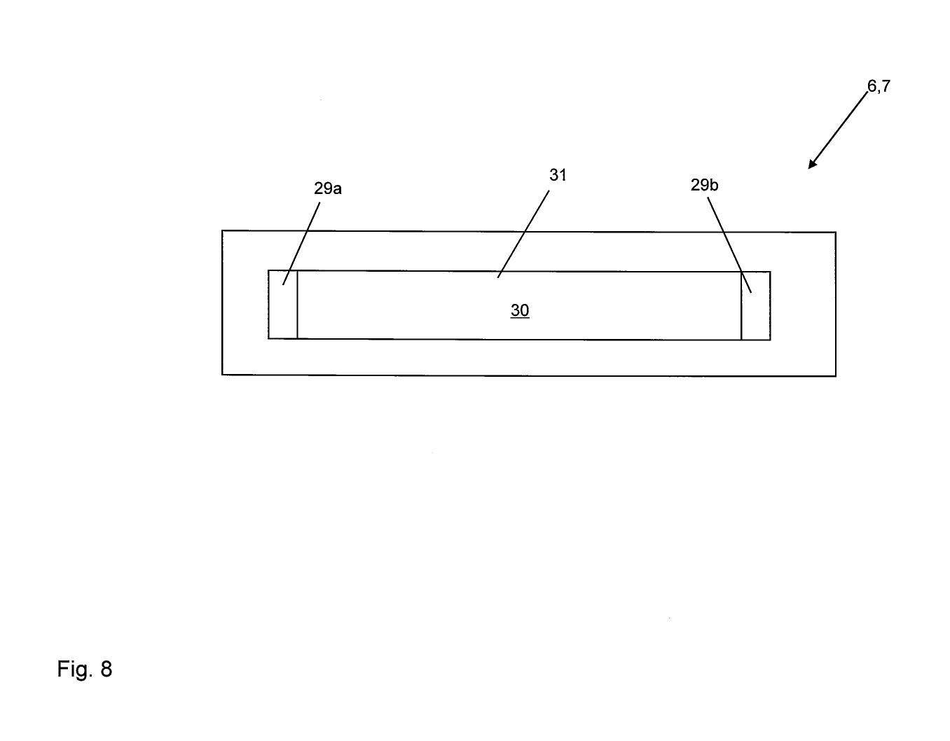

In FIG. 8, a further channel end plate is depicted in a schematic front top view, which can be designed as an anode plate 6 or cathode plate 7. The channel end plate 6, 7 has two stack openings 29 a, b, which are connected to each other by a third integrated channel section 30, such that a third channel 31 is formed. The third channel 31 is designed, for example, as a deviation of fluids, which come from the stack 2 and are conducted back into it.

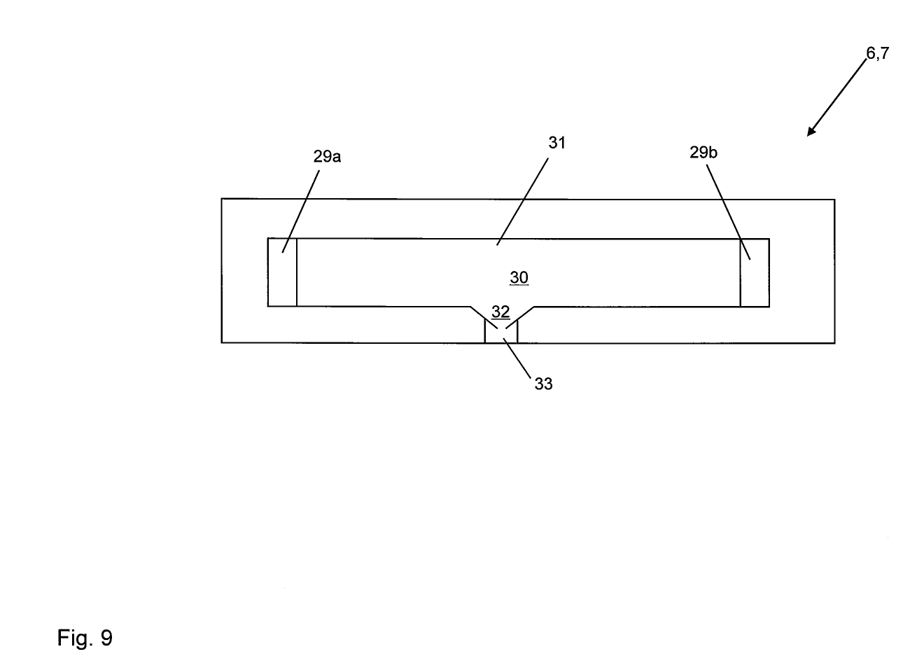

In the same depiction, a further channel end plate 6, 7 is depicted in FIG. 9, which has the same details as in the preceding figure, such that reference is made to the corresponding description. In contrast to the preceding figure, the third channel 31 is, however, designed as a water separator with a separation region 32, which has a separation opening 33, via which water collected in the separation region 32 can be discharged.

The anode plate 6 and the cathode plate 7 can be produced as a material hybrid, wherein a functional support can be fitted, adhered or spattered onto a carrier structure, made from, for example, metal or a fiber-reinforced synthetic material. For example, the functional support serves to seal the anode plate 6 and the cathode plate 7 to the housing 5. Furthermore, the functional support can implement an electrical insulation between the stack 2 and the atmosphere. In particular, the functional support can be provided in such a way that the insulating clearance formed by the first channel 15 is electrically insulated from the frame and/or coolant.

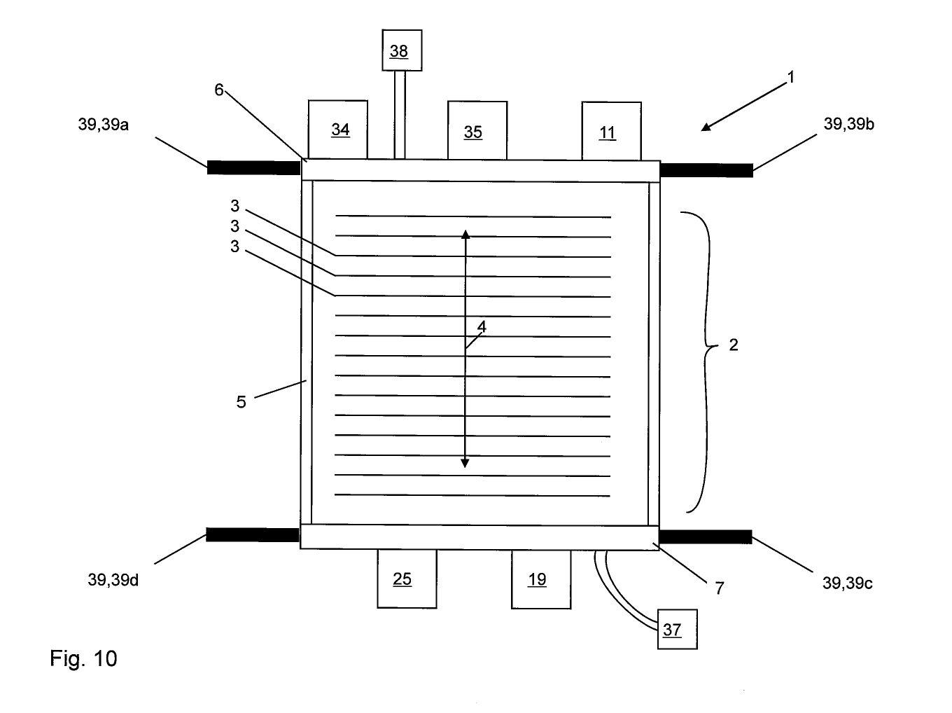

FIG. 10 shows a potential constructive design of the fuel cell arrangement 1 in FIG. 1. Several system components are arranged on the anode plate 6 for conducting and/or conditioning the fuel. The system components cited below are directly connected, for example bolted, to the anode plate 6. This has the advantage that long pipeworks between the anode plate 6 and the system components can be dispensed with, such that susceptibility to defects of the fuel cell module 1 can be reduced.

A first system component is a recirculation fan 34, which is designed to accelerate partially consumed fuel in a recirculation branch from an outlet of the stack 2 and to transport it to an inlet of the stack 2. A second potential system component is a water separator 35, which is designed to discharge water from the partially consumed fuel in the cited recirculation branch.

A further potential system component is a mixing valve 36, which is designed to mix partially consumed fuel from the recirculation branch with fresh fuel, before this mixture is introduced into the fuel cell stack 2.

The humidifier 25 is arranged as a first system component on the cathode plate 7, which is designed to humidify the oxidant during water supply, so as to condition this for the fuel cells 3. A second potential system component on the cathode plate 7 is the coolant heater 19, which is designed to temper the coolant for the fuel cell stack 2. The coolant heater 19 can also be arranged on the anode plate 6 in modified exemplary embodiments.

Additionally, the fuel cell arrangement 1 has an electrical interface 37 for discharging the generated electrical energy and, if necessary, for exchanging control signals. Furthermore, the fuel cell arrangement 1 comprises a fluidic interface 38, which is designed to supply fuel, supply and discharge coolant and, optionally, additionally supply the oxidant.

In addition, the fuel cell arrangement 1 has a mechanical interface 39, which comprises four interface sections 39a, b, c, d in the exemplary embodiment shown. The interface sections 39a to d are directly connected to the anode plate 6 or the cathode plate 7 and serve to attach the fuel cell arrangement 1 in the vehicle. In particular, the interface sections 39a-d can be designed integrally with the carrier structure. Thus, the interface sections 39 a-d are attached to the anode plate 6 or cathode plate 7 at one end, and to the vehicle at the other, free end.

At least 95% of the weight and the loads of the fuel cell arrangement 1 are removed via the mechanical interface 39. The electrical interface 37 and the fluidic interface 38 serve, however, only to provide the fluids or to provide electrical contact. In particular, the system components are each at least 95% attached to the anode plate 6 or cathode plate 7 with respect to their weight.

The advantage of this design is that, for a dismantling, construction or exchange of the fuel cell arrangement 1, only the electrical interface 37, the fluidic interface 38 and the mechanical interface 39 must be detached, and then the fuel cell arrangement 1 can be exchanged.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1. Fuel cell arrangement
2. Stack
3. Fuel cells
4. Stack direction
5. Housing
6. Anode plate
7. Cathode plate
8. Hydrogen inlet
9. Hydrogen outlet
10. Coolant inlet
11. Coolant outlet
12. Oxidant inlet
13. Oxidant outlet
14. Bypass inlet
15. First channel
16. Coolant inlet opening
17. Coolant stack opening
18. First channel section
19. Coolant heater
20. Oxidant inlet opening
21. Bypass inlet opening
22. Oxidant stack opening
23. Second channel section
24. Second channel
25. Humidifier
26. Interference contours
27. Bypass
28. Flow deflector
29. Stack opening
30. Third channel section
31. Third channel
32. Discharge region
33. Discharge opening
34. Recirculation branch
35. Water separator
36. Mixing valve
37. Electrical interface
38. Fluidic interface
39. Mechanical interface

1-13. (canceled)

14. A fuel cell stack arrangement, comprising:
a plurality of fuel cells; and
a first and a second end plate, wherein the plurality of fuel cells are arranged in the form of a stack between the first and second end plates,
wherein at least one of the first and second end plates is a channel end plate with at least one channel, wherein the channel has a first stack opening, which is opened in the direction of the stack, and a second opening, and wherein the first stack opening and the second opening are connected to each other via a channel section,
wherein the first stack opening and the second opening are arranged, in a top view looking down on the at least one channel end plate, at a distance to each other.

15. The fuel cell stack arrangement of claim 14, wherein the channel is configured to conduct a fuel, oxidant or coolant.

16. The fuel cell stack arrangement of claim 14, wherein the second opening is a second stack opening.

17. The fuel cell stack arrangement of claim 14, wherein the second opening is an external opening.

18. The fuel cell stack arrangement of claim 17, wherein the channel is configured to carry a coolant and the channel includes an insulating section.

19. The fuel cell stack arrangement of claim 14, wherein the channel is configured as part of an oxidant supply and the channel includes a swirl region.

20. The fuel cell stack arrangement of claim 19, wherein the channel has two external openings and the first stack opening, wherein a first of the external openings and a second of the external openings is coupled to an oxidant humidifier or a bypass to the oxidant humidifier respectively.

21. The fuel cell stack arrangement of claim 14, wherein the channel is a cascade or a water separator.

22. The fuel cell stack arrangement of claim 14, further comprising:
a housing, in which the stack is arranged, wherein the housing is locked and sealed at an end of the housing by the first and second end plates.

23. The fuel cell stack arrangement of claim 14, wherein the first and second end plates are configured as a material hybrid having a carrier structure made from a first material and a functional support made from a second material.

24. The fuel cell stack arrangement of claim 23, wherein the first material is a fiber composite or as a metallic material and the second material is a synthetic material.

25. The fuel cell stack arrangement of claim 23, wherein the functional support forms a sealing between the first and second end plates and the housing and/or a raw material for the channel section.

26. The fuel cell stack arrangement of claim 14, further comprising:
further system components arranged on the first and second end plates to conduct and/or condition fluids and are borne by the further system components.
